(19) United States
(12) Patent Application Publication
(10) Pub. No.: US 2017/0160859 A1
(43) Pub. Date: Jun. 8, 2017

(54) DUAL-MODE TOUCH SENSING METHOD AND STYLUS AND TOUCH PANEL FOR THE SAME

(71) Applicant: SILICON INTEGRATED SYSTEMS CORP., Hsinchu City (TW)

(72) Inventors: Chia-Yi CHU, Hsinchu City (TW); Song Sheng LIN, Hsinchu City (TW)

(73) Assignee: SILICON INTEGRATED SYSTEMS CORP., Hsinchu City (TW)

(21) Appl. No.: 15/230,278

(22) Filed: Aug. 5, 2016

(30) Foreign Application Priority Data
Jul. 29, 2015 (TW) 104124575

(51) Int. Cl. G06F 3/041; G06F 3/0488; G06F 3/038; G06F 3/0354

(52) U.S. Cl. CPC G06F 3/0416; G06F 3/03545; G06F 3/04883; G06F 3/0383; G06F 2203/04106; G06F 2203/0384

(57) ABSTRACT

A dual-mode touch sensing method adapted for a stylus and a touch panel comprising N first signal lines and M second signal lines. The method comprises: sequentially controlling the N first signal lines to emit N corresponding pulse signals in N gesture periods in a scanning period, receiving M gesture feedback signals corresponding to the pulse signals via the M second signal lines in each among the N gesture periods, selectively generating a gesture signal based on the gesture feedback signals, determining a stylus period other than the N gesture periods in the scanning period by the stylus, generating a stylus signal in the stylus period by the stylus, and receiving the stylus signal and generating a stylus touching signal accordingly by the touch panel.

### CROSS-REFERENCE TO RELATED APPLICATIONS

This non-provisional application claims priority under 35 U.S.C. §119(a) on Patent Application No(s). 104124575 filed in Taiwan, R.O.C. on Jul. 29, 2015, the entire contents of which are hereby incorporated by reference.

### TECHNICAL FIELD

This disclosure is related to a touch sensing method and stylus and touch panel applicable for the method, and particularly related to a dual-mode touch sensing method and stylus and touch panel applicable for the method.

### BACKGROUND

The touch sensing technology is applied in a variety of electronic devices since the touch sensing technology was developed. In early years, a stylus is used as an input mechanism in this field, and then gesture sensing is developed. In recent years, the stylus and the gesture sensing can be integrated so that the dual-mode input is a common means of touch sensing in many electronic devices.

However, there is an obstacle of false-sensing in the dual-mode input mechanism. If an electronic device recognizes an input by a stylus when the user of the electronic device is actually input command with his/her finger, vice versa, this situation is called false-sensing. Hence, it is an issue to be conquered that how an electronic device tells a gesture input from a stylus input when a user controls the electronic device with these two ways meanwhile.

### SUMMARY

A dual-mode touch sensing method in one embodiment of the disclosure is applicable for a stylus and a touch panel having N first signal lines and M second signal lines, and the method includes the steps of: sequentially controlling the N first signal lines to emit N corresponding pulse signals within N gesture periods in a scanning period, receiving M corresponding gesture feedback signals by the M second signal lines within each of the N gesture periods, selectively generating a gesture signal according to the gesture feedback signals, determining at least one stylus period other than the gesture periods in the scanning period according to the N pulse signals by the at least one stylus, emitting a stylus signal by the at least one stylus in the stylus period, and receiving the stylus signal to generate a stylus touching signal by the touch panel.

According to one embodiment of the disclosure, the stylus comprises: a wireless receiving module for wirelessly receiving at least one pulse signal from a touch panel; a processing module electrically connected to the wireless receiving module, for determining a stylus period corresponding to the touch panel according to the at least one pulse signal, and selectively generating a stylus signal during the stylus period; and a wireless transmitting module electrically connected to the processing module and for emitting the stylus signal.

According to one embodiment of the disclosure, the touch panel comprises: N first signal lines; M second signal lines, overlapping with and not connected to the N first signal lines; and a touch processing module, respectively electrically connected to the N first signal lines and the M second signal lines, for sequentially controlling the N first signal lines to emit N corresponding pulse signals during N gesture periods in a scanning period, and selectively generating a gesture signal according to M gesture feedback signals received by the M second signal lines, and controlling the N first signal lines and the M second signal lines to receive a stylus signal during each of N stylus periods in the scanning period, and selectively generating a stylus touching signal according to at least one stylus feedback signal corresponding to the stylus signal; wherein ith gesture period among the N gesture period is timing adjacent to ith stylus period among the N stylus periods; wherein M and N are both integers larger than one, and i is a positive integer less than or equal to N.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a part of the diagram illustrating the touch panel according to one embodiment of the disclosure;

FIG. 2 is a block diagram of a stylus according to one embodiment of the disclosure;

FIG. 3 is a signal timing diagram according to one embodiment of the disclosure;

FIG. 4 is a signal timing diagram according to another embodiment of the disclosure; and

FIG. 5 is a flowchart of the dual-mode touch sensing method according to one embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

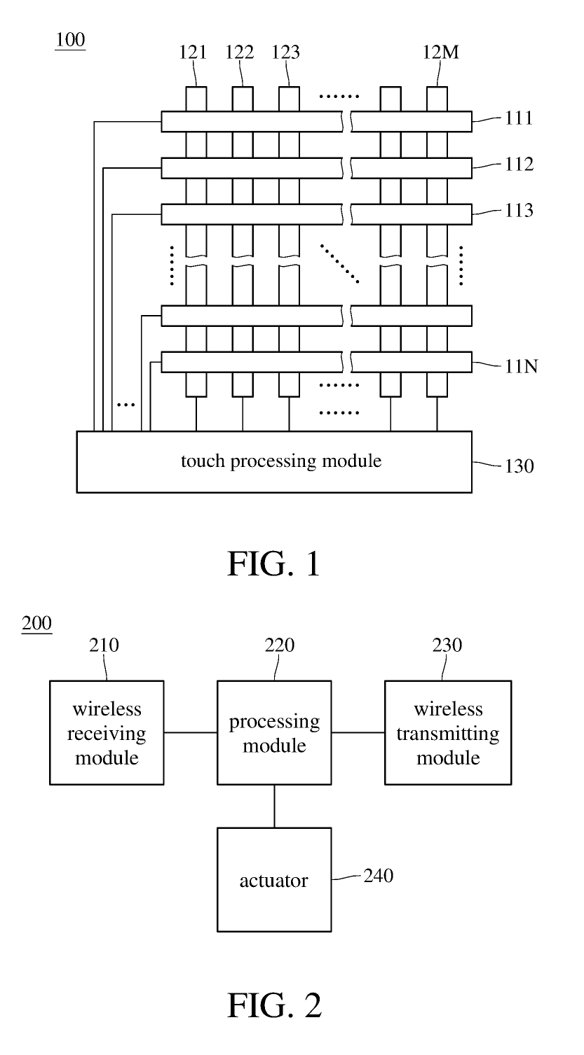

Please refer to FIG. 1 and FIG. 2, wherein FIG. 1 illustrates a portion of a touch panel according to one embodiment of the disclosure, and FIG. 2 illustrates a functional block diagram of a stylus according to one embodiment of the disclosure. As shown in FIG. 1, the touch panel 100 includes N first signal lines 111˜11N, M second signal lines 121˜12M, and a touch processing module 130. It is understood according to FIG. 1 that N and M are integers larger than one. The first signal lines are not parallel to the second signal lines and overlapping over the second signal lines. The touch processing module 130 is respectively electrically connected to the N first signal lines 111˜11N and the M second signal lines 121˜12M, and the first signal lines are not directly connected to the second signal lines. As shown in FIG. 2, the stylus 200 includes a wireless receiving module 210, a processing module 220, and a wireless transmitting module 230. The processing module 220 is respectively electrically connected to the wireless receiving module 210 and the wireless transmitting module 230. In certain embodiments, the wireless receiving module 210 and the wireless transmitting module 230 is integrated as a wireless transceiver.

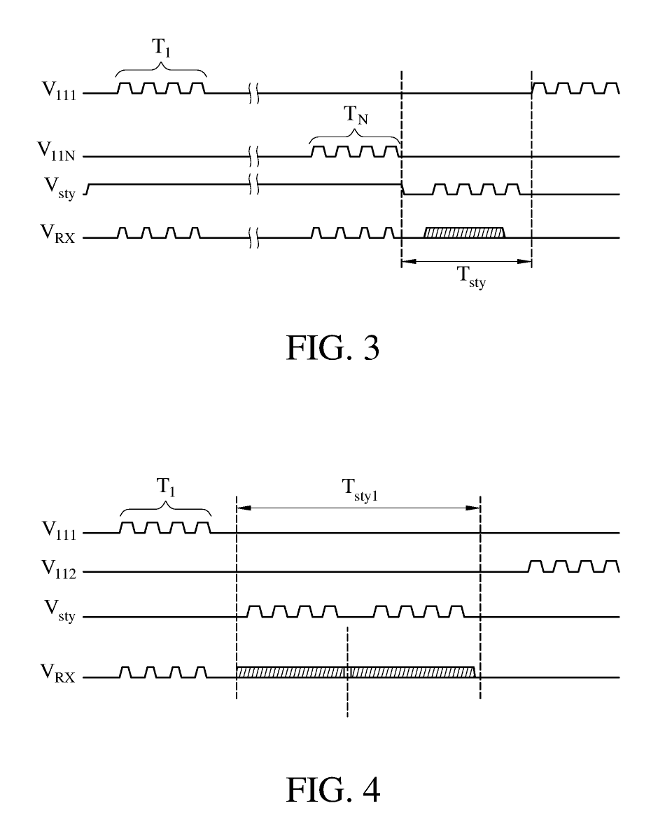

Please refer to FIG. 3, which illustrates a timing diagram of signals according to one embodiment of the disclosure. As shown in FIG. 3, the scanning period Tscan is defined as a period the touch panel 100 scanning a touch of a user's finger and/or a touch by the stylus 200. In one embodiment, a scanning period Tscan is divided into a stylus period Tsty and N gesture period, denoted from T1 to TN. In the gesture period T1, the touch processing module 130 controls the first signal lines 111 to transmit at least one pulse signal, so the voltage V111 on the first signal line 111 varies during the gesture period T1. Meanwhile, the touch processing module 130 controls the M second signal lines 121˜12M to respectively receive the gesture feedback signals corresponding to the at least one pulse signal so that the voltage VRX on the second signal lines also varies. Specifically, the gesture feedback signal when the touch panel 100 is touched by a finger is different from the gesture feedback signal when the touch panel 100 is not touched by the finger. Hence, the touch processing module 130 is capable of determining whether at least one cross-section among the M cross-sections between the first signal lines 111 and the second signal lines 121˜12M is touched by a user's finger or any other object. During the gesture period T1 through the gesture period TN, the touch processing module 130 performs the same functionality. Hence, if the touch processing module 130 determines the second signal line 12q is touched by a finger during the gesture period Tk, it means that the cross-section between the first signal line 11k and the second signal line 12q is touched by the finger.

In the embodiment, there is a stylus period Tsty after the gesture period TN. In the at least one pulse signal emitted by the first signal line 111 in the gesture period T1 includes information about when this pulse signal is generated. For example, the at least one pulse signal emitted by the first signal line 111 is decoded so that a flag 0x1 is obtained. Similarly, the at least one pulse signal emitted by the first signal line 11N is decoded so that a flag 0xN is obtained. Hence, if the stylus 200 is close to the first line 11k the most, the processing module 220 decodes a pulse signal after the pulse signal is received by the wireless receiving module 210 and the flag 0xk is obtained. After the processing module 220 decodes to obtain the flag 0xk for several times, the processing module 220 is capable of obtaining a length of a scanning period Tscan according to a period between two adjacent flags 0xk. After the length of the scanning period Tscan is determined, the processing module 220 is capable of obtaining a timing difference between the stylus period Tsty and the gesture period Tk. Hence, in the stylus period Tsty, the processing module 220 controls the wireless transmitting module 230 to emit the stylus signal. Hence, the voltage Vsty varies during the stylus period Tsty.

In another embodiment, the at least one pulse signal emitted by each of the first signal lines is embedded with a timing difference information corresponding to the pulse signal and the stylus period Tsty. For example, assume that N equals to 100, and the length of a scanning period Tscan is 9 ms, and the length of each gesture period is 80 us. The timing difference between the gesture period T1 and the stylus period Tsty is 7.92 ms. The pulse signal emitted by the first signal line 111 is embedded with this information, so the processing module 220 decodes the pulse signal received by the wireless receiving module 210 to obtain this timing information. 7.92 ms latter, the processing module 220 controls the wireless transmitting module 230 to emit the stylus signal. The stylus signal is identical or inverse to the pulse signal emitted by the first signal line 11N.

In yet another embodiment, there is a prompt period between the Nth gesture period TN and the stylus period Tsty. During the prompt period, the touch processing module 130 controls each of the first signal lines to emit the prompt signal. When the wireless receiving module 210 in the stylus 200 receives the prompt signal, the processing module 220 controls the wireless transmitting module 230 to emit the stylus signal. In one embodiment, the prompt signal is embedded with information about a length of the stylus period, so the processing module 220 controls the wireless transmitting module 230 to emit the stylus signal precisely during the stylus period Tsty.

In one embodiment, during the stylus period Tsty, the first signal lines 111 through 11N are not emitting the pulse signal(s), but the first signal lines are not switched to receive the pulse signal. The second signal lines 121 through 12M are still enabled to receive the pulse signal and/or the stylus signal. In other words, the first signal lines are used for emitting the pulse signal and the second signal lines are used for receiving the sensed pulse signal, during the gesture period. During the stylus period, the first signal lines and the second signal lines may both be used for receiving the stylus signal. Otherwise, only the second signal lines 121 through 12M are used for receiving the stylus signal. If both the first signal line 11i and the second signal line 12j receive the stylus signal, the touch processing module 130 determines the position of the stylus 200 is on the cross-section between the first signal line 11i and the second signal line 12j, and the stylus touching signal is generated therefore. In another embodiment, the touch processing module 130 collects (M+N) stylus feedback signal from the first signal lines 111 through 11N and the second signal lines 121 through 12M, and determines the position of the stylus 200 according to the intensity of each of the stylus feedback signal.

In yet another embodiment, the stylus signal is embedded with further control information such as texture of drawing lines, the width of drawing lines, etc. The touch processing module 130 embedded those control information and the piece of position information of the stylus 200 into the stylus touching signal.

In still another embodiment, please refer back to FIG. 2, the stylus 200 further includes an actuator 240 electrically connected to the processing module 220∘ The actuator 240 is, for example, a button, and has a first state (released) and a second state (pressed). The processing module 220 does not generate the stylus signal when the actuator 240 is in the first state. Otherwise, the processing module 220 generates the stylus signal.

In one embodiment, please refer to FIG. 4, which illustrates a signal timing diagram according to another embodiment of the disclosure. As shown in FIG. 4, a scanning period Tscan is divided into a stylus period Tsty and N gesture period, denoted from T1 to TN. In the gesture period T1, the touch processing module 130 controls the first signal lines 111 to transmit at least one pulse signal, so the voltage V111 on the first signal line 111 varies during the gesture period T1. Meanwhile, the touch processing module 130 controls the M second signal lines 121˜12M to respectively receive the gesture feedback signals corresponding to the at least one pulse signal so that the voltage VRX on the second signal lines also varies. Specifically, the gesture feedback signal when the touch panel 100 is touched by a finger is different from the gesture feedback signal when the touch panel 100 is not touched by the finger. Hence, the touch processing module 130 is capable of determining whether at least one cross-section among the M cross-sections between the first signal lines 111 and the second signal lines 121˜12M is touched by a user's finger or any other object. During the gesture period T1 through the gesture period TN, the touch processing module 130 performs the same functionality. Hence, if the touch processing module 130 determines the second signal line 12q is touched by a finger during the gesture period Tk, it means that the cross-section between the first signal line 11k and the second signal line 12q is touched by the finger.

In the embodiment, there is a stylus period Tsty1 between the gesture period T1 and the gesture period T2. Similarly, the ith stylus period is timing adjacent to the ith gesture period. If the stylus 200 is located between the first signal line 111 and the first signal line 112, the processing module 220 would determine that there is a stylus period Tsty1 between the gesture period T1 and T2 after the stylus 200 receives the pulse signal emitted by the first signal line 111 and 112 for several times. The processing module 220 then controls the wireless transmitting module 230 to emit the stylus signal during the stylus period Tsty1.

The touch processing module 130 of the touch panel 100 then collects M stylus feedback signal from the second signal lines during each of the N stylus period. The touch processing module 130 then determines the position of the stylus 200 according to the intensity of each of the M×N stylus feedback signal. In the embodiment, if there is no stylus signal received, the intensity of the stylus feedback signal is set to be zero.

In one embodiment, during the stylus period Tsty1, the first signal lines 111 through 11N are disabled so they neither emit the pulse signal nor used for receiving the stylus signal. The second signal lines 121 through 12M are still enabled to receive the stylus signal. In other words, during the gesture period(s), the first signal lines are used for emitting the pulse signal and the second signal lines are used for receiving the sensed pulse signal. During the stylus period(s), the first signal lines are disabled so as to reduce the power consumption, and the second signal lines are used for receiving the stylus signal from the stylus 200.

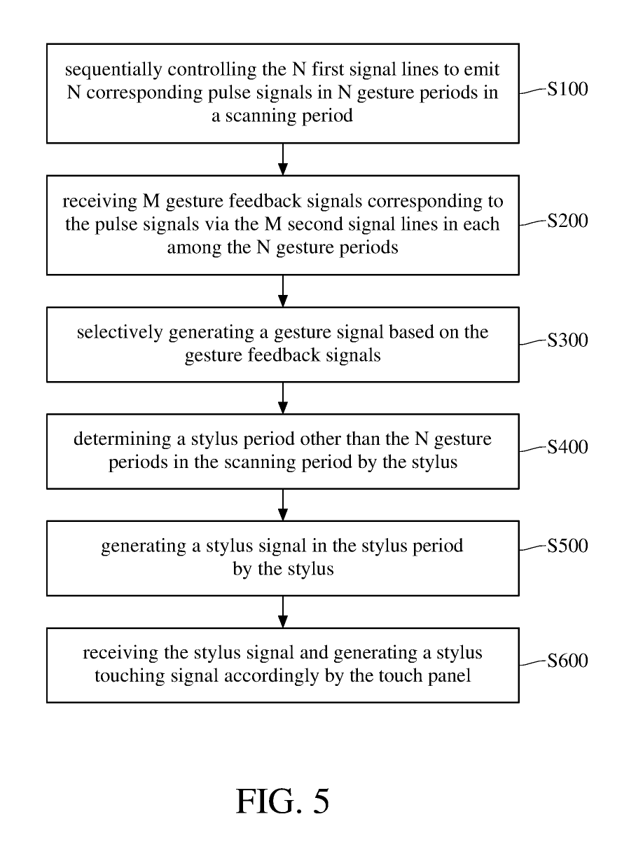

Please refer to FIG. 1, FIG. 2, and FIG. 5 for understanding a dual-mode touch sensing method according to one embodiment of the disclosure, wherein FIG. 5 illustrates a flowchart of the dual-mode touch sensing method according to one embodiment of the disclosure. As shown in step S100, the touch processing module 130 of the touch panel 100 sequentially controls the N first signal lines 111 through 11N to emit N corresponding pulse signals during N gesture periods in a scanning period. As shown in step S200, receiving M gesture feedback signals corresponding to the pulse signals via the M second signal lines in each among the N gesture periods. As shown in step S300, the touch processing module 130 selectively generates a gesture signal according to the gesture feedback signals. As shown in step S400, the stylus 200 determines at least one stylus period in the scanning period and other than the N gesture periods according to the N pulse signals. As shown in step S500, the stylus 200 emits a stylus signal during the stylus period. As shown in step S600, the stylus signal is received by the second signal lines and/or the first signal lines of the touch panel 100 so as to generate the stylus touching signal.

As above, the method, stylus, and touch panel according to one or more embodiment of the disclosure provides that the stylus period for sensing the stylus signal is determined by the touch panel. The stylus obtains the stylus period according to the pulse signal emitted from the touch panel so as to emit the stylus signal during the stylus period. Hence, the touch panel is prevented from false-sensing a finger touch as a stylus input, or vise versa.

What is claimed is:

1. A dual-mode touch sensing method, applicable for a touch panel and at least one stylus, wherein the touch panel comprises N first signal lines and M second signal lines, wherein N and M are both integers larger than one, and the method comprises the steps of:
sequentially controlling the N first signal lines to emit N corresponding pulse signals within N gesture periods in a scanning period;
receiving M corresponding gesture feedback signals by the M second signal lines within each of the N gesture periods;
selectively generating a gesture signal according to the gesture feedback signals;
determining at least one stylus period other than the gesture periods in the scanning period according to the N pulse signals by the at least one stylus;
emitting a stylus signal by the at least one stylus in the stylus period; and
receiving the stylus signal to generate a stylus touching signal by the touch panel.

2. The method in claim 1, wherein the stylus touch signal comprises:
a piece of position information corresponding to the at least one stylus generating the stylus signal;
a piece of stylus touching information corresponding to the stylus; and
a piece of feedback information of the at least one stylus.

3. The method in claim 2, wherein an amount of the at least one stylus period is one, and the stylus signal is received respectively by the M second signal lines or by the N first signal lines coincidentally.

4. The method in claim 3, wherein an i^{th} pulse signal among the N pulse signal further comprises a piece of timing difference information between an i^{th} gesture period among the N gesture periods and the stylus period, and i is a positive integer less than or equal to N.

5. The method in claim 3, further comprising:
controlling each of the first signal lines to generate a prompt signal during a prompt period after the N^{th} gesture period;
wherein the stylus period is after the prompt period.

6. The method in claim 3, wherein the piece of position information is determined according to (M+N) stylus feedback signals received by the N first signal lines and the M second signal lines.

7. The method in claim 2, wherein the at least one stylus period includes N stylus periods, i^{th} stylus period among the N stylus periods is adjacent in timing to i^{th} gesture period among the N gesture periods, and i is an integer less than or equal to N.

8. The method in claim 7, wherein the N first signal lines are disabled during the N stylus periods.

9. The method in claim 7, further comprising:
collecting M×N stylus feedback signals received by the M second signal lines during the N stylus periods; and
determining the piece of position information according to the M×N stylus feedback signals.

10. A stylus, comprising:
a wireless receiving module for wirelessly receiving at least one pulse signal from a touch panel;
a processing module electrically connected to the wireless receiving module, for determining a stylus period corresponding to the touch panel according to the at least one pulse signal, and selectively generating a stylus signal during the stylus period; and
a wireless transmitting module electrically connected to the processing module and for emitting the stylus signal.

11. The stylus in claim 10, wherein each of the at least one pulse signal comprises a piece of timing information corresponding to a timing the pulse signal is generated, and the processing module determines the stylus period according to the piece of timing information, wherein the timing information is used for indicating a timing difference between the pulse signal and the stylus period.

12. The stylus in claim 10, wherein the at least one pulse signal comprises an indicating signal for indicating a start point corresponding to the stylus period, and the processing module determines a preset period beginning from a negative edge of the indicating signal as the stylus period.

13. The stylus in claim 10, further comprising an actuator electrically connected to the processing module, and the actuator has a first state and a second state, when the actuator is in the first state, the processing module does not generate the stylus signal, and when the actuator is in the second state, the processing module generates the stylus signal.

14. A touch panel, comprising:
N first signal lines;
M second signal lines, overlapping with and not connected to the N first signal lines; and
a touch processing module, respectively electrically connected to the N first signal lines and the M second signal lines, for sequentially controlling the N first signal lines to emit N corresponding pulse signals during N gesture periods in a scanning period, and selectively generating a gesture signal according to M gesture feedback signals received by the M second signal lines, and controlling the N first signal lines and the M second signal lines to receive a stylus signal during each of N stylus periods in the scanning period, and selectively generating a stylus touching signal according to at least one stylus feedback signal corresponding to the stylus signal;
wherein i^{th} gesture period among the N gesture period is timing adjacent to i^{th} stylus period among the N stylus periods;
wherein M and N are both integers larger than one, and i is a positive integer less than or equal to N.
